(19) United States
(12) Patent Application Publication
(10) Pub. No.: US 2026/0312663 A1
(43) Pub. Date: Oct. 8, 2026

(54) SELECTION OF SPATIAL FILTERS IN REPEATER-ASSISTED NETWORKS

(71) Applicant: TELEFONAKTIEBOLAGET LM ERICSSON (PUBL), STOCKHOLM (SE)

(72) Inventors: Magnus Åström, Lund (SE); Boris Dortschy, Stockholm (SE); Andreas Nilsson, Göteborg (SE); Behrooz Makki, Göteborg (SE); Lei Bao, Göteborg (SE)

(21) Appl. No.: 19/100,857

(22) PCT Filed: Aug. 1, 2023
(86) PCT No.: PCT/IB2023/057814

§ 371 Date: Feb. 3, 2025

Related U.S. Application Data
(60) Provisional application No. 63/394,233, filed on Aug. 1, 2022.

(51) Int. Cl. H04B 7/06; H04B 7/04; H04W 8/22; H04W 72/231; H04W 76/20

(52) U.S. Cl. CPC H04B 7/0696; H04B 7/04013; H04B 7/0617; H04W 8/22; H04W 72/231; H04W 76/20

(57) ABSTRACT

The present disclosure relates to a method for enabling a network node to efficiently control the beam switching of a set of periodic and/or aperiodic signals/channels at an assisting repeater. The method at a repeater node includes receiving one or more periodic beam configurations and receiving one or more dynamic beam indications. The method also includes selecting a periodic beam configuration or a dynamic beam indications to use for a time interval based on a prioritization order, and then applying the periodic beam configuration or dynamic beam indication for a beam of a transmission. The method at a network node includes determining a priority list for a plurality of repeater spatial filters for a repeater node, and the providing the repeater node with one or more periodic beam configurations based on the priority list and one or more dynamic beam indications.

### RELATED APPLICATIONS

This application claims the benefit of U.S. Provisional Pat. App. No. 63/394,233, filed Aug. 1, 2022, the disclosure of which is hereby incorporated herein by reference in its entirety.

### TECHNICAL FIELD

The present disclosure relates to a selection of a spatial filter in repeater-assisted networks in a wireless communications network.

### BACKGROUND

### Network Controlled Repeater

To increase the data rate and support the increasing number of User Equipment devices (UEs), different methods are considered, among which network densification and Millimeter Wave (mmW) communications are the dominant ones. Network densification refers to the deployment of multiple access points of different types in, e.g., metropolitan areas. Particularly, it is expected that in future small nodes, such as relays, Integrated Access and Backhaul (IAB), repeaters, etc., will be densely deployed to support existing macro Base Stations (BS) serving UEs.

During the Third Generation Partnership Project (3GPP) Release 16 (Rel-16) and Release 17 (Rel-17), IAB has been well studied as the main relaying technique in Fifth Generation (5G), and the discussions will continue in Release 18 (Rel-18) on mobile IAB. Here, using a decode-and-forward relaying technique, the IAB can extend the coverage and/or increase the throughput. However, IAB may be a relatively complex and expensive node and, thereby, depending on the deployment, there may be a need for alternative nodes with low complexity/cost for, e.g., blind spot removal. Here, a candidate type of network node is the Radio Frequency (RF) repeaters which simply amplify-and-forward any signal that they receive. RF repeaters have been considered in Second Generation (2G), Third Generation (3G), and Fourth Generation (4G) to supplement the coverage provided by regular full-stack cells. However, RF repeater lacks accurate beamforming which may limit its efficiency in, for instance, Frequency Range 2 (FR2).

With this background, a new study-item has been considered in 3 GPP Rel-18 (Study Item 1), started in early 2022, in which the potentials and the challenges of Network-Controlled Repeaters (NCR) will be evaluated. The scope and the features of NCR are still under discussion. FIG. 1 gives an example of an NCR deployment where the wireless connection between the NCR 104 and the gNB 102 is referred to as a backhaul link 108, whereas the wireless connection between the NCR 104 and the UE 106 is referred to as access link 110. The backhaul link can include control signaling from the gNB 102 to the NCR 104.

In one alternative, a network-controlled repeater can be a normal repeater with beamforming capabilities. In this way, the NCR should be considered as a network-controlled “beam bender” when compared to a gNB. As such, it is logically part of the gNB for all management purposes, i.e., it is likely that the network-controlled repeater is deployed and under the control of the operator. NCR is based on an amplify-and-forward relaying scheme, and it is likely to be limited to single-hop communication in stationary deployments with the focus on FR2.

In particular, the network-controlled repeater study item considers the following focus for the study-item:
Network-controlled repeaters are inband RF repeaters used for extension of network coverage on Frequency Range 1 (FR1) and FR2 bands, while during the study FR2 deployments may be prioritized for both outdoor and Outdoor-to-Indoor (O2I) scenarios;
For only single hop stationary network-controlled repeaters;
Network-controlled repeaters are transparent to UEs; and
Network-controlled repeater can maintain the gNB-repeater link and repeater-UE link simultaneously.

Also, the study-item will concentrate on identifying which side control information is required:
Beamforming information;
Timing information to align transmission/reception boundaries of network-controlled repeater;
Information on UL-DL Time Division Duplex (TDD) configuration;
ON-OFF information for efficient interference management and improved energy efficiency; and
Power control information for efficient interference management.

How an NCR will be designed and how it will communicate with the network is still not clear. FIG. 2 illustrates one schematic example of how it might look. In this example, the NCR 104 consists of three principal building blocks, the modem module 206, the controller module 208, and the repeater module (depicted as the two amplifiers 202 and 204 in FIG. 2). The NCR 104 is equipped with an antenna configuration, where a signal is first received in downlink (DL) or uplink (UL), and, e.g., after power amplification, transmitted further in DL (or UL). Since the repeater module (also referred to as NCR-Forward (Fwd)) only amplifies and (analogously) beamforms the signal, no advanced receiver or transmitter chains are required, which reduce the cost and energy consumption compared to for example a normal Transmission and Reception Point (TRP). In its simplest architecture, different antenna modules are used for the donor and service sides, i.e., the antennas targeting the gNB 102 and UEs 106, respectively, whereas a more complex architecture, including self-interference cancellation, would allow for using the same antenna modules for both sides.

The modem module 206 is able and used to exchange control and status signaling with a gNB that is controlling the NCR 104. For this, the modem module 206 supports at least a sub-set of UE functions. NCR control and status information is further exchanged between the modem module 206 and the controller module 208. The modem module 206 might be equipped with antennae separated from the antennae used by the repeater module; but, in most configurations, the modem module 206 and Repeater module will share antenna configurations.

The controller module 208 is used to control the repeater module (202 and 204), by for example providing beamforming information, power control information, etc. The controller module 208 is connected to the network through the modem module 206 such that the network can control the controller module 208 and, in that way, control the repeater module (202 and 204).

Both, the modem module 206 and controller module 208, can be assumed to be part of building up a Mobile Termination (MT) function in the NCR 104.

The Repeater module's amplify-and-forward operation is controlled by the controller module 208. The controller module 208 could also be directly responsible for the beamforming control on the service antenna side, i.e., to/from served UEs 106. In an alternative, the beamforming on the service antenna side is operated by the repeater module (202 and 204) under control of the controller module 208. On the donor antenna side, i.e., to/from the controlling gNB 102, the modem module 206 could be directly responsible for the beamforming control. In an alternative, the beamforming on the service antenna side is operated by the repeater module 202 and 204 under control of the controller module 208 and/or Modem module 206.

In one configuration, the modem module 206 and the repeater module 202 and 204 do not only share an antenna configuration but also parts of the (analog) transmitter and/or receiver, such as power (transmit) amplifier and/or receiver amplifiers and/or filters.

The modem module 206 and the repeater module (202 and 204) could be operating at the same or different frequencies. For example, the repeater module (202 and 204) could operate at a high frequency band (FR2) and the modem module 206 could be operating at a low frequency band (FR1).

### Reconfigurable Intelligent Surface (RIS)

Intelligent Reflecting Surfaces (IRS), also known as Reconfigurable Intelligent Surfaces (RIS), are an emerging technology that is capable of intelligently manipulating the propagation of electro-magnetic waves. RIS is composed of a 2-dimensional array of reflecting elements, where each element acts as a passive reconfigurable scatterer, i.e., a piece of manufactured material, which can be programmed to change an impinging electro-magnetic wave in a customizable way. Such elements are usually low-cost passive surfaces that do not require dedicated power sources, and the radio waves impinged upon them can be forwarded without the need of employing power amplifier or RF chain. Moreover, RIS can, potentially, work in full duplex mode without significant self-interference or increased noise level and requires only low-rate control link or backhaul connections. RIS can be flexibly deployed due to its low weight and low power consumption. Specially, RIS is of interest in stationary or low-mobility networks, in which the transmission parameters can be well planned and, e.g., blockages/tree foliage is bypassed through RIS-assisted communication.

There are still ambiguities about the detailed differences of the network-controlled repeaters and RISs. A simple explanation is that an RIS is a network-controlled repeater with negative amplification. In general, RIS is expected to be a simpler and cheaper node with less focused beamforming capability/accuracy and without active amplification. That is, RIS may be capable of signal reflection via adapting a phase matrix while the network-controlled repeater is capable of advanced beamforming with power amplification. Also, delay wise, RIS may have slightly lower latency, compared to network-controlled repeater. In 3GPP, RIS-assisted communication has been recently suggested by some companies as a possible technology to be considered in Rel-18 network-controlled repeater study-item. For instance, RIS has been discussed in 3GPP Technical Specification Group (TSG) Radio Access Network (RAN) Rel-18 workshop, June 2021 [2]. Then, while specification-wise a network-controlled repeater is likely to be a superset of the RIS, it is not unlikely that RIS-specific features are discussed in the Rel-18 study-item on network-controlled repeaters.

An RIS might have a similar design as the network-controlled repeater exemplified in FIG. 2, but without the signal amplification step in the repeater module.

### NR Multi-Beam Operation

### Beam Management Procedure

In high frequency range (FR2), multiple RF beams may be used to transmit and receive signals at a gNB and a UE. For each DL beam from a gNB, there is typically an associated best UE Receive (Rx) beam for receiving signals from the DL beam. The DL beam and the associated UE Rx beam forms a beam pair. The beam pair can be identified through a so-called beam management process in NR.

A DL beam is (typically) identified by an associated DL Reference Signal (RS) transmitted in the beam, either periodically, semi-persistently, or aperiodically. The DL RS for the purpose can be a Synchronization Signal (SS)/Physical Broadcast Channel (PBCH) Block (SSB) or a Channel State Information RS (CSI-RS). By measuring all the DL RSs, the UE can determine and report to the gNB the best DL beam to use for DL transmissions. The gNB can then transmit a burst of different DL-RSs in the reported best DL beam to let the UE evaluate candidate UE Rx beams.

Although not explicitly stated in the NR specification, beam management has been divided into three procedures, schematically illustrated in FIG. 3:
P-1 302: Purpose is to find a coarse direction for the UE using wide gNB Transmit (Tx) beam covering the whole angular sector.
P-2 304: Purpose is to refine the gNB Tx beam by doing a new beam search around the coarse direction found in P-1.
P-3 306: Used for UE that has analog beamforming to let them find a suitable UE Rx beam.

P-1 302 is expected to utilize beams with rather large beamwidths and where the beam reference signals are transmitted periodically and are shared between all UEs of the cell. Typically reference signal to use for P-1 302 are periodic CSI-RS or SSB. The UE then reports the N best beams to the gNB and their corresponding Reference Signal Received Power (RSRP) values.

P-2 304 is expected to use aperiodic/or semi-persistent CSI-RS transmitted in narrow beams around the coarse direction found in P-1 302.

P-3 306 is expected to use aperiodic/or semi-persistent CSI-RSs repeatedly transmitted in one narrow gNB beam. One alternative way is to let the UE determine a suitable UE Rx beam based on the periodic SSB transmission. Since each SSB consists of four Orthogonal Frequency-Division Multiplexing (OFDM) symbols, a maximum of four UE Rx beams can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two of its antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for Tracking RS (TRS) and the Physical Downlink Shared Channel (PDSCH) Demodulation Reference Signal (DMRS). When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its Rx beam in some direction prior to receiving a certain signal. If the UE knows that the signal is spatially QCL with some other signal it has received earlier, then it can safely use the same Rx beam to also receive this signal.

In NR, the spatial QCL relation for a DL or UL signal/channel can be indicated to the UE by using a “beam indication.” The “beam indication” is used to help the UE to find a suitable RX beam for DL reception, and/or a suitable Tx beam for UL transmission. In NR, the “beam indication” for DL is conveyed to the UE by indicating a Transmission Configuration Indicator (TCI) state to the UE, while in UL the “beam indication” can be conveyed by indicating a DL-RS or UL-RS as spatial relation (in NR Rel-15/16) or a TCI state (in NR Rel-17).

In the present disclosure, the terminology “repeater node” refers to a network-controlled repeater or a Reconfigurable Intelligent Surface, RIS, or nodes with similar types of functionality, i.e., receiving a signal and instantaneously forwarding it in another direction, unless otherwise stated.

In the present disclosure, the terminology “repeater spatial filters” refers to repeater node beams, or precoders.

There currently exist certain challenge(s). In NR, the beam indication is used to help the UE to find a suitable Rx beam for DL reception, and/or a suitable Tx beam for UL transmission. The beam indication for DL is conveyed to the UE by indicating a TCI state to the UE, while in UL the beam indication can be conveyed by indicating a DL-RS or UL-RS as spatial relation (in NR Rel-15/16) or a TCI state (in NR Rel-17). The beam mapping between a UL/DL beam index and a DL-RS or UL-RS in a TCI state is left to the implementation of the gNB and UE. In other words, the gNB and the UE do not need to know about the beam arrangement at the other side. In case of, e.g., repeater-assisted networks, since the repeater nodes are controlled by the gNB, the gNB will need to know about all the repeater beams and geometrical relations between them, e.g., through repeater beam indices. Regarding how to control the repeater beam switching during operation, the controller module and the repeater module may know about the semi-static TDD pattern (e.g., from System Information Block (SIB)1), i.e., slots and symbols used for different signals/channel, but it does not and will not need to know the instantaneous UE scheduling, for example:
If there is any UE scheduled for Physical Downlink Shared Channel (PDSCH), Physical Uplink Shared Channel (PUSCH), or Physical Uplink Control Channel (PUCCH);
Which UE is scheduled for PDSCH/PUSCH/PUCCH; and
If a repeater beam switching will take place when one type of signals/channels is changed to another type of signals/channels, or different UEs are served in consecutive PDSCH slots, etc.

FIG. 4 gives an example to illustrate time domain operations at the gNB and the repeater node, with respect to different signals/channels (PDCCH, PDSCH, PUSCH, PUCCH, SSB, or Physical Random Access Channel (PRACH), over 10 consecutive Slots (SL), when serving UE1 and UE2. For example, in SL0 402, the cell common PDCCH is broadcasted to the repeater node and both UE1 and UE2; whilst the PDSCH is scheduled to UE1, repeater node and UE2 in SL0 402, SL1 404 and SL3 406, respectively. The diagonal line indicates the time resource is not used in communication e.g., between gNB and repeater node, or between the repeater node and UE1, etc. The diagonal striped pattern (in the last row) represents the time resource the repeater module is in use, i.e., where a repeater beam switching (on the access link) may take place.

Generally speaking, the time location of a certain type of signal or channel is well designed according to the specification. For periodic signals/channels, the associated beam-to-use will also be rather static and periodic over time. It is, therefore, preferred that the periodic signals/channels can be semi-statically configured. On the other hand, the signals/channels which depend on dynamic scheduling (i.e., which UE to serve) will need a dynamic beam indication, which can adapt to the real time propagation and traffic condition. In NR, different signals/channels have different priority order depending on the purpose and importance of the signals/channels. Since the repeater node is not expected to have signal/channel awareness, there is a need of a method to develop overhead efficient signaling which is used by the gNB to provide periodic and aperiodic beam configuration in an efficient manner, which also takes the priorities of different signals/channels into consideration.

### SUMMARY

The present disclosure relates to a method for enabling a network node to efficiently control the beam switching of a set of periodic and/or aperiodic signals/channels at an assisting repeater. The method at a repeater node includes receiving one or more periodic beam configurations and receiving one or more dynamic beam indications. The method also includes selecting a periodic beam configuration or a dynamic beam indication to use for a time interval based on a prioritization order, and then applying the periodic beam configuration or dynamic beam indication for a beam of a transmission. The method at a network node includes determining a priority list for a plurality of repeater spatial filters for a repeater node, and the providing the repeater node with one or more periodic beam configurations based on the priority list and one or more dynamic beam indications.

In an embodiment, a method performed by a repeater node for configuring a spatial filter of a repeater forwarding function can be provided. The method can include receiving, from a network node, one or more periodic beam configurations. The method can also include receiving, from the network node, one or more dynamic beam indications. The method can also include selecting a periodic beam configuration from the one or more periodic beam configurations or a dynamic beam indication from the one or more dynamic beam indications to use for a time interval based on a prioritization order. The method can also include applying the periodic beam configuration or the dynamic beam indication for a beam of a transmission.

In another embodiment, a repeater node for configuring a spatial filter of a repeater forwarding function can be provided, where the repeater node includes processing circuitry configured to receive, from a network node, one or more periodic beam configurations. The processing circuitry can also be configured to receive, from the network node, one or more dynamic beam indications. The processing circuitry can also be configured to select a periodic beam configuration from the one or more periodic beam configurations or a dynamic beam indication from the one or more dynamic beam indications to use for a time interval based on a prioritization order. The processing circuitry can also be configured to apply the periodic beam configuration or the dynamic beam indication for a beam of a transmission.

In another embodiment, a method for configuring a spatial filter of a repeater forwarding function by a network node can be provided. The method can include the network node determining a priority list for a plurality of repeater spatial filters for a repeater node. The method can also include providing the repeater node with one or more periodic beam configurations based on the priority list. The method can also include providing the repeater node with one or more dynamic beam indications.

A network node for configuring a spatial filter of a repeater forwarding function can be provided, where the network node includes processing circuitry configured to determine a priority list for a plurality of repeater spatial filters for a repeater node. The processing circuitry can also provide the repeater node with one or more periodic beam configurations based on the priority list and provide the repeater node with one or more dynamic beam indications.

Certain embodiments may provide one or more of the following technical advantages. The present disclosure provides methods at a network node to configure periodic behavior of spatial filter configurations of a repeater node and thereby facilitate the control of the repeater node beams by the network node. The proposed method does not require the repeater node to have an understanding of the signals/channels,. Especially, in order to enable flexible configuration/signaling to forward different signals/channels, the present disclosure proposes to introduce a prioritization signaling and, thereby, allow the repeater node to apply the appropriate beams based on received beam configuration/indication priorities.

Particularly, the proposed scheme enables the integration of the network-controlled repeaters or Reconfigurable Intelligent Surfaces (RISs) into the network and improves the coverage extension. In this way, the network-controlled repeater helps to efficiently, e.g., bypass the blockages and avoid performance drop (beam link failure) of the user equipments (UEs).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a diagram that illustrates a network-controlled repeater in a wireless communication system according to an embodiment of the present disclosure;

FIG. 2 is a block diagram of a network-controlled repeater according to an embodiment of the present disclosure;

FIG. 3 is an example of a beam management procedure according to an embodiment of the present disclosure;

FIG. 4 is an illustration of time domain operations at a network node and a repeater node according to an embodiment of the present disclosure;

FIG. 5 is a block diagram of a repeater-assisted network according to an embodiment of the present disclosure;

FIG. 6 depicts a flowchart of a method performed by a repeater node for configuring a spatial filter of a repeater forwarding function according to an embodiment of the present disclosure;

FIG. 7 depicts the flowchart of a method for configuring a spatial filter of a repeater forwarding function of a repeater node by the network node according to an embodiment of the present disclosure;

FIG. 8 shows an example of a communication system according to an embodiment of the present disclosure;

FIG. 9 shows a user equipment according to an embodiment of the present disclosure;

FIG. 10 shows a network node according to an embodiment of the present disclosure;

FIG. 11 is a block diagram of a host according to an embodiment of the present disclosure;

FIG. 12 is a block diagram illustrating a virtualization environment 1200 in which functions implemented by some embodiments may be virtualized according to an embodiment of the present disclosure; and

FIG. 13 shows a communication diagram of a host communicating via a network node with a UE over a partially wireless connection according to an embodiment of the present disclosure.

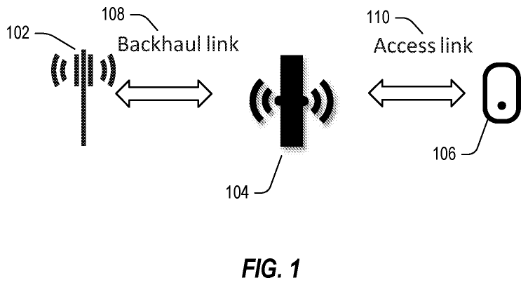

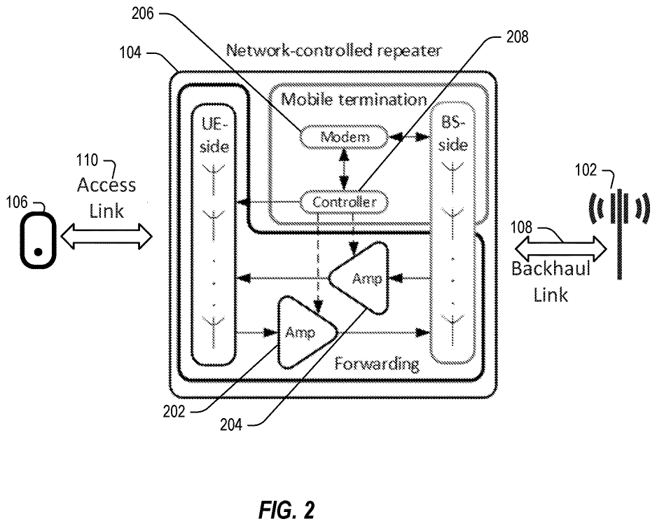

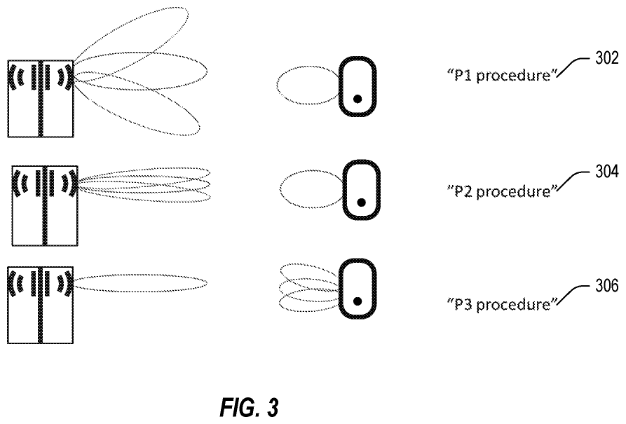

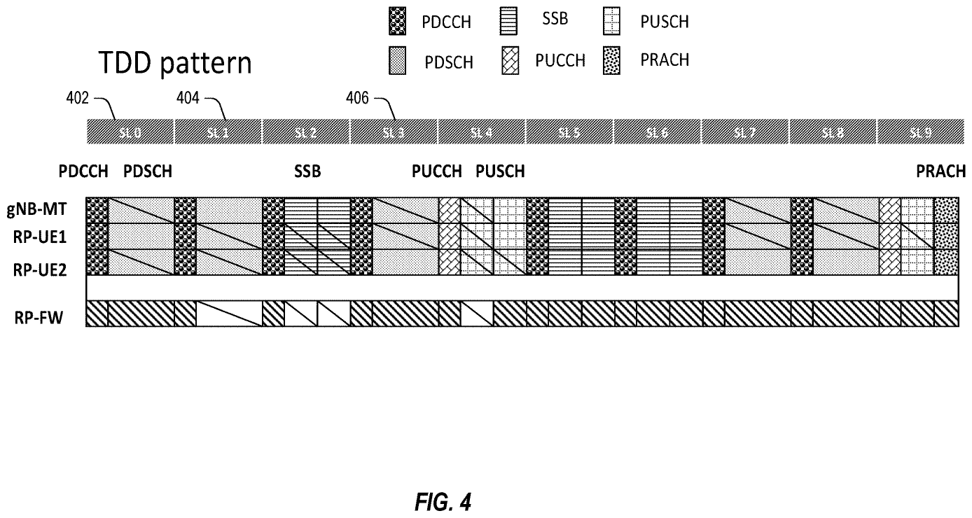

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In this present disclosure the terminology “repeater node” refers to a network-controlled repeater or a Reconfigurable Intelligent Surface, RIS, or nodes with similar types of functionalities, unless otherwise stated.

Certain aspects of the disclosure and their embodiments may provide solutions to the challenges described above. Signaling methods are disclosed that enable the network node to efficiently control the beam switching of a set of periodic and/or aperiodic signals/channels at the assisting repeater node, using, e.g., repeater beam indices, or a reference signal in the Transmission Configuration Indicator (TCI) configuration, etc.

Certain embodiments may provide one or more of the following technical advantages. The present disclosure provides methods at a network node to configure periodic behavior of spatial filter configurations of a repeater node and thereby facilitate the control of the repeater node beams by the network node. The proposed method does not require the repeater node to have an understanding of the signals/channels. Especially, in order to enable flexible configuration/signaling to forward different signals/channels, the present disclosure proposes to introduce a prioritization signaling and, thereby, allow the repeater node to apply the appropriate beams based on received beam configuration/indication priorities.

Particularly, the proposed scheme enables the integration of the network-controlled repeaters/RISs into the network and improves the coverage extension. In this way, the network-controlled repeater helps to efficiently, e.g., bypass the blockages and avoid performance drop (beam link failure) of the UEs.

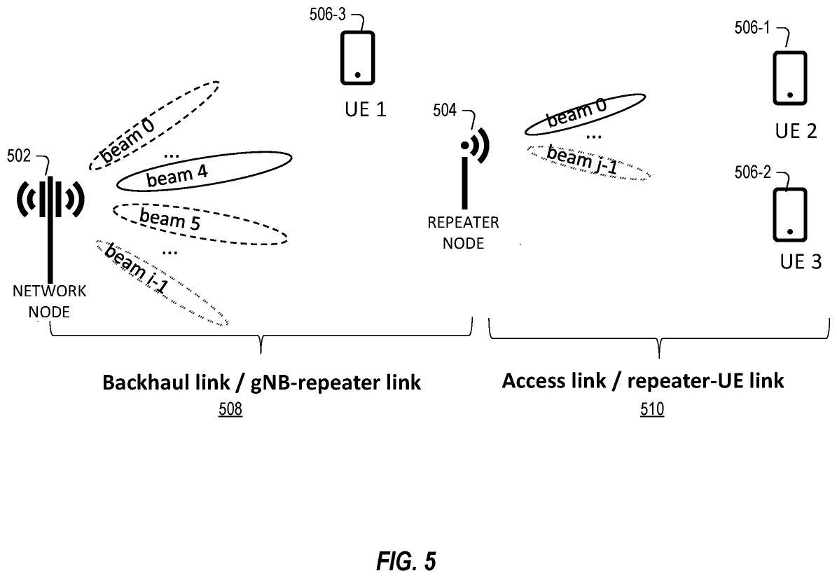

As depicted in FIG. 5, the system model considers a network node 502 (e.g., a gNB) communicating with one or more destination nodes 506-1, 506-2, and 506-3 (e.g., User Equipment (UE)s) in wireless communication links that are relayed by a repeater node 504 (e.g., network-controlled repeater or reconfigurable intelligent surface, etc.). The destination nodes 506-1, 506-2, and 506-3 may also in addition to, or alternately, be directly linked to the network node 502.

The method enables the network node 502 to configure the periodic and/or aperiodic behavior of spatial filter configuration of a repeater forwarding function of the repeater node 504 with different priorities. Although targeting spatial filtering (beamforming), in a wider scope, this may also include disabling of the repeater operation (null beam).

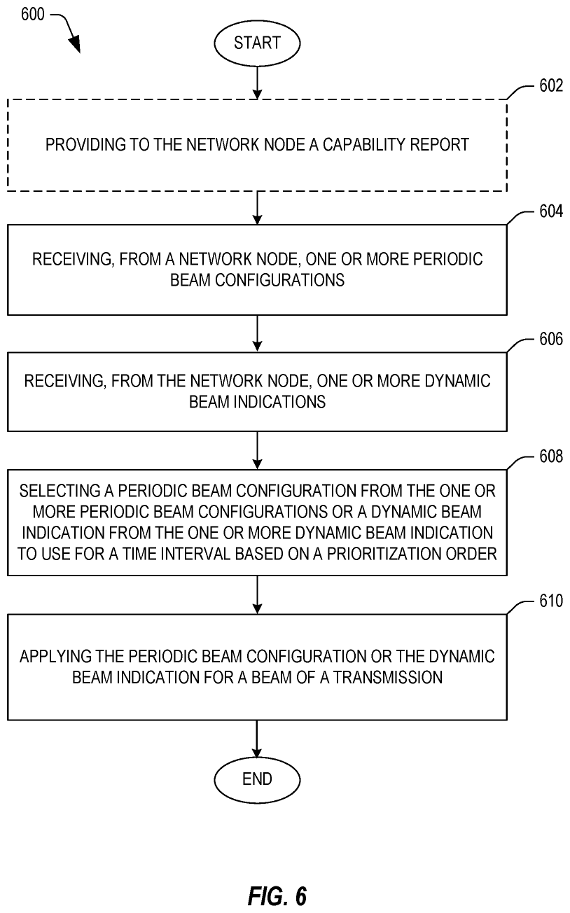

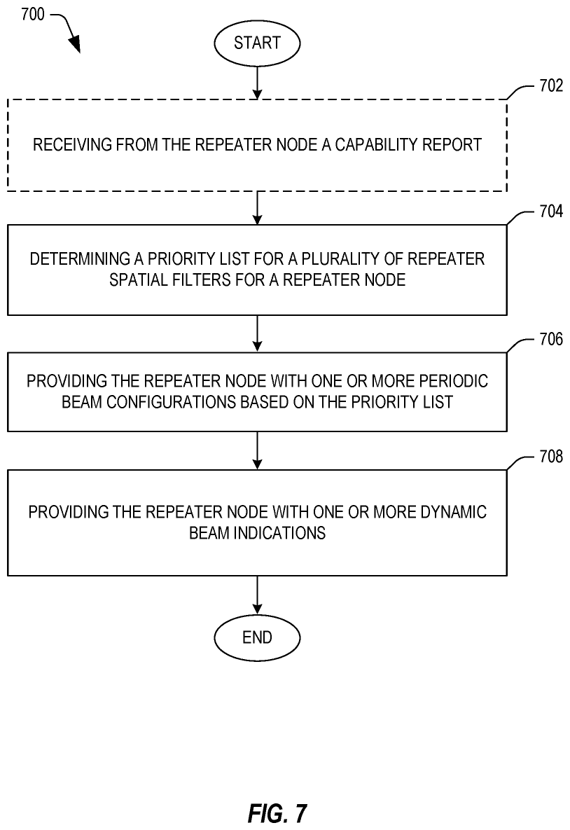

FIG. 6 depicts a flowchart 600 of a method performed by a repeater node (e.g., repeater node 504) for configuring a spatial filter of a repeater forwarding function. It is to be appreciated that in FIGS. 6 and 7, boxes with dashed lines can be optional steps.

The method can begin in an optional first step at step 602, where the method includes providing to the network node 502 a capability report. The capability report can include a repeater beam arrangement report containing repeater beam capabilities and beam information for each type of repeater beam, regarding one or more of:
Size of antenna plane (X-by-Y) and/or number of fundamental (Discrete Fourier Transform (DFT)) beams (X-by-Y);
A beam hierarchy, for example, beam constellation (horizontal X-axis by vertical Y-axis, or relative position to bore sight, etc.) for beam hierarchy level, and or beam configuration for lower beam hierarchy level, e.g., a set of M by N beams for, say, every beam of the higher beam hierarchy;
Number of beams of each type of beam (for example different types of beams have different beamwidths). The number of beams can be reported as number of vertical beams and number of horizontal beams;
Beam direction relation between different beams for a beam type (adjacent versus non-adjacent beam direction);
Polarization of the beam;
Maximum number of beams that the repeater node 504 can be configured with;
Beam Switching Delay/Latency Information;
Number of Repeater Beam Switches per Slot Information;
Beam expansion capability, including possible limitations in the beam expansion capability;
A frequency band in which the repeater can operate;
Sub-band properties of the repeater for said frequency band, including e.g., the number of sub-bands within the frequency band;
Repeater ON/OFF capability, i.e., the capability to disabling the repeating function; and
Semi-static configuration capability, i.e., the capability to receiving semi-static configurations.

The signaling of capability reporting can be for example via Radio Resource Control (RRC), Medium Access Control (MAC) Control Element (MAC-CE), etc. Note that the “beam arrangement report” can comprise several different parts where each part can contain different information, as for example listed above.

In one detailed embodiment, the repeater beams are indicated in the beam arrangement report using e.g., beam index, or beam identification (ID), or beam index of a parent beam index in a beam hierarchy, or a reference signal in a TCI configuration, etc. In another detailed embodiment, the repeater indicates a capability of beam expansion together with its antenna array or plane properties, e.g., number of antenna elements in X and Y dimensions, or its Fundamental (FFT) phased array beam properties, i.e., how many different narrow beams the repeater can form, in X and Y dimensions.

In one embodiment, the repeater node 504 may include the repeater node's capability on decoding/processing beam indication control side information, regarding one or more of
Semi-static beam configuration;
Semi-persistent beam configuration; and
Dynamic beam configuration.

Note that a semi-persistent beam configuration is a periodic beam configuration which is activated over a certain period; therefore, it can be treated in a similar manner as the periodic beam configuration in this present disclosure.

In another embodiment, the repeater node 504 may report to the network node 502 about its latency capability regarding e.g., processing time needed for decoding side control information, and/or maximum/minimum beam switching time for Uplink (UL)/Downlink (DL) etc.

In one embodiment, the repeater node 504 may report its capability to disabling the repeating functionality, including a delay for disabling/enabling the repeater node 504.

In one embodiment, the repeater node 504 may report a capability of in which frequency band it is capable of repeating, including the repeater bandwidth and an associated capability of repeating in sub-bands such that different sub-bands may be configured differently.

In step 604 the repeater node 504 receives, from network node 502, one or more periodic beam configurations.

In one embodiment, the one or more of periodic repeater beam configurations are conveyed in e.g., RRC, MAC-CE signaling etc.

In one embodiment, the repeater node 504 can be provided with one common periodic beam configuration which contains all periodic signals/channels to be forwarded between the network node 502 and the UEs 506. In one detailed embodiment, the common periodic beam indication is associated with a periodicity which is the longest periodicity among the periodic signals/channels to be forwarded, e.g., the periodicity of the periodic Channel State Information Reference Signal (CSI-RS) resources.

In one embodiment, the repeater node 504 can be provided with multiple periodic beam configurations, where each configuration is semi-static and associated with a periodicity which is recurring with one periodic signal/channel or one group of periodic signals/channels to be forwarded. In one detailed embodiment, the periodicity of one beam configuration can be same as, or shorter than, or longer than the periodicity of the Time Division Duplex (TDD) pattern, e.g., according to the RRC parameter TDD-UL-DL-configurationCommon.

In step 606, the repeater node 504 receives one or multiple dynamic beam indications (or aperiodic beam configurations) from the network node 502.

In one embodiment, the dynamic beam indications are conveyed in e.g., Downlink Control Information (DCI) etc.

In one embodiment, network node 502 indicates the set of repeater beams-to-use based on the information in the repeater beam arrangement report using one or more of
Repeater beam index/Identification (ID);
Repeater beam index/ID +repeater beam type index/ID;
Repeater beam polarization index/ID; and
Reference signal in the TCI configuration.

In one embodiment, the configuration of the beam time-domain state includes one or more of:
System frame number;
Sub-frame number;
Slot number;
Slot periodicity;
Duration in number of slots;
Symbol number;
Starting Orthogonal Frequency Division Multiplexing (OFDM) symbol in a slot;
Ending OFDM symbol in a slot; and
Duration in number of OFDM symbols in a slot.

It should be noted that the periodic beam configuration may comprise a periodic beam time-domain state and a periodic beam-to-use, whilst the dynamic beam indication may comprise a periodic beam time-domain state and an aperiodic beam-to-use, or an aperiodic beam time-domain state and an aperiodic beam-to-use.

In one embodiment, the beam configuration/indication can be related to other repeater node configurations such as:
Repeater Forwarding (FWD) OFF configuration, in which case the repeater access side is not expected to be operable, and only the repeater Modem module is practically active. In one embodiment, the OFF configuration could be or result from a certain beam index outside the range of actual beam indices.
Repeater INACTIVE or IDLE, in which case the whole repeater becomes inactivated at various levels. This could be, e.g., in a shopping mall outside opening hours.
Beam amplification level, i.e., which amplification should be applied for the beam.
   In one embodiment the beam amplification factor is different depending on the beamwidth of the repeater node's spatial filter. In one example, the larger the beamwidth that is used, the higher the amplification factor is (to compensate for the lower antenna gain when applying spatial filters with larger beamwidths).

In step 608, the repeater node 504 selects which periodic beam configuration or dynamic beam indication and consequently which beam to use for a time interval (beam time-domain state).

In one embodiment, each time-domain state in a periodic beam configuration and/or a dynamic beam indication is configured with a prioritization order which is based on the importance of the underlying signals/channels to be forwarded and/or on which carrier/serving cell the signal/channel is scheduled on.

In an alternative embodiment, each periodic beam configuration and/or dynamic beam indication is provided with a prioritization order as configured by the network node 502.

In an alternative embodiment, the priority is defined by a prioritization flag with two states: can be overridden and cannot be overridden, respectively. In case a beam configuration/indication can be overridden, the later received beam configuration/indication will override the earlier received beam configuration/indication. In one alternative embodiment, only periodic beam configurations are provided with the prioritization flag.

In yet another embodiment, the dynamic beam indication is associated with a reference to a/the periodic beam configuration, for example a dedicated beam index of the dynamic beam indication (e.g., DCI) is used to indicate application of the periodic beam configuration which is prioritized over the dynamic beam indication.

In step 610, the repeater node 504 applies the appropriate beam for a transmission to one of UEs 506 according to the received periodic beam configuration in step 604 and/or dynamic beam indications in step 606 and the determination in step 608.

FIG. 7 depicts the flowchart 700 of a method for configuring a spatial filter of a repeater forwarding function of a repeater node 504 by the network node 502.

In an optional first step 702, the network node 502 receives a capability report from the repeater node 504, including a repeater beam arrangement report containing repeater beam capabilities and beam information for each type of repeater beam, regarding one or more of:
Size of antenna plane (X-by-Y) and/or number of fundamental (DFT) beams (X-by-Y).
A beam hierarchy, for example beam constellation (horizontal X-axis by vertical Y-axis, or relative position to bore sight, etc.) for beam hierarchy level, and or beam configuration for lower beam hierarchy level, e.g., a set of M by N beams for, say, every beam of the higher beam hierarchy.
Number of beams of each type of beam (for example different types of beams have different beamwidths). The number of beams can be reported as number of vertical beams, and number of horizontal beams.
Beam direction relation between different beams for a beam type (adjacent versus non-adjacent beam direction).
Polarization of the beam.
Maximum number of beams that the repeater node can be configured with.
Beam Switching Delay/Latency Information.
Number of Repeater Beam Switches per Slot Information.
Beam expansion capability, including possible limitations in the beam expansion capability.
A frequency band in which the repeater can operate.
Sub-band properties of the repeater for said frequency band, including e.g., the number of sub-bands within the frequency band.
Repeater ON/OFF capability, i.e., the capability to disabling the repeating function.
Semi-static configuration capability, i.e., the capability to receiving semi-static configurations.

The signaling of capability reporting can be via RRC, MAC-CE, and etc. Note that the “beam arrangement report” can comprise several different parts where each part can contain different information, as for example listed above.

In one embodiment, the repeater beams are indicated in the beam arrangement report using e.g., beam index, or beam ID, or beam index of a parent beam index in a beam hierarchy, or a reference signal in a TCI configuration, etc. In another embodiment, the repeater node 504 indicates a capability of beam expansion together with its antenna array or plane properties, e.g., number of antenna elements in X and Y dimensions, or its fundamental (FFT) phased array beam properties, i.e., how many different narrow beams the repeater node 504 can form, in X and Y dimensions.

In one embodiment, the repeater node 504 may include the repeater node's capability on decoding/processing beam indication control side information, regarding one or more of:
Semi-static beam configuration;
Semi-persistent beam configuration; and
Dynamic beam configuration.

Note that a semi-persistent beam configuration is a periodic beam configuration which is activated over a certain period, therefore it can be treated in a similar manner as the periodic beam configuration in this present disclosure.

In step 704, the method includes determining a priority list for a plurality of repeater spatial filters for a repeater node. The network node 502 can determine and configure the priorities for one or more of periodic beam configurations in some embodiments, and in other embodiments, the network node 502 determines and configures the priorities for one or more of dynamic beam indications.

In an embodiment, the beam time-domain states can be associated with different prioritization rules, based on the importance of the underlying signals/channels to be forwarded and/or for which carrier/serving cell the signal/channels are scheduled on. The repeater node 504 configuration may, e.g., result in that:
periodic cell common signals/channels are prioritized over aperiodic UE specific signals/channels;
periodic cell common signals/channels are prioritized over periodic reference signals;
certain aperiodic UE specific signals/channels are prioritized over periodic reference signals; and
the prioritization orders are determined based on which carrier/serving cell the signal/channel to be forwarded are scheduled on (for example signal/channels scheduled on the primary cell might have higher priority than signal/channels scheduled on secondary cells).

In one embodiment, each time-domain state in a periodic beam configuration and/or a dynamic beam indication is configured with a prioritization order which is based on the importance of the underlying signals/channels to be forwarded and/or on which carrier/serving cell the signal/channel is scheduled on.

In an alternative embodiment, each periodic beam configuration and/or dynamic beam indication are configured with a prioritization order which is based on the importance of the underlying signals/channels to be forwarded and/or on which carrier/serving cell the signal/channel is scheduled on. In one detailed embodiment, the number of priorities is determined by the network node 502, or Operations, Administration, and Maintenance (OAM), etc. In another detailed embodiment, the number of priorities is specified in the specification.

In an alternative embodiment, the priority is defined by a prioritization flag with two states: can be overridden and cannot be overridden, respectively. In case a beam configuration/indication can be overridden, the later received beam configuration/indication will override the earlier received beam configuration/indication. In one alternative embodiment, only periodic beam configurations are provided with the prioritization flag.

In one embodiment, the dynamic beam indication is associated with a reference to a/the periodic beam configuration, for example a dedicated beam index of the dynamic beam indication (e.g., DCI) is used to indicate application of the periodic beam configuration which is prioritized over the dynamic beam indication.

In one embodiment, the network node 502 may indicate to the repeater node 504 about the DL/UL direction associated to an indicated beam. In one example, the DL/UL direction can be dynamically provided by, e.g., DCIs, or those upper layer parameters.

In step 706, the method includes the network node 502 providing the repeater node 504 with one or more periodic beam configurations based on the priority list.

In one embodiment, the one or more of periodic repeater beam configurations are conveyed in e.g., RRC, MAC-CE signaling, etc. In one embodiment, some parts of a periodic beam configuration can be updated dynamically using DCI and/or MAC-CE, for example the spatial filters (beams) that the periodic beam configuration is associated with could be updated dynamically. This could be useful for example if a UE is configured with UE/Network-Controlled Repeaters (NCR)-Mobile Termination (MT) specific periodic Sounding Reference Signal (SRS)/CSI-RS transmission, and the UE moves around in the cell, causing the need for the repeater node to update its spatial filter towards the UE. Since the time domain behavior of the SRS transmission will be the same, it would be overhead and latency efficient if only the spatial filter settings associated with that periodic beam configuration could be updated dynamically.

In one embodiment, the repeater node 504 can be provided with one common periodic beam configuration which contains all periodic signals/channels to be forwarded between the network node 502 and the UEs 506. In one detailed embodiment, the common periodic beam indication is associated with a periodicity which is the longest periodicity among the periodic signals/channels to be forwarded, e.g., the periodicity of the periodic CSI-RS resources.

In one embodiment, the repeater node 504 can be provided with multiple periodic beam configurations, where each configuration is semi-static and associated with a periodicity which is recurring with one periodic signal/channel or one group of periodic signals/channels to be forwarded. In one detailed embodiment, the periodicity of one beam configuration can be same as, or shorter than, or longer than the periodicity of the Time Division Duplex (TDD) pattern, e.g., according to the RRC parameter TDD-UL-DL-configurationCommon.

In one embodiment, the periodic repeater beam configuration is associated to forward different types of periodic cell common signals/channels, e.g., Synchronization Signal Block (SSB), System Information Blocks (SIBs), Tracking Resource Signal (TRS), Coreset 0, paging, Physical Random Access Channel (PRACH), etc. In one example, each periodic beam configuration is associated to forward one type of periodic signal/channel. In another example, one periodic beam configuration is associated to forward a group of periodic signals/channels.

Although the repeater node 504 may not be aware of specific signals or channels, the association is highly relevant for the network node 502 in its configuration of the repeater node 504 such that it configures the repeater node 504 according to the properties of the aforementioned signals and channels.

In a further embodiment, the periodic repeater beam configuration is associated to forwarding periodic reference signals used for UE measurement in beam/radio link monitoring, or cell reselection, etc. The reference signals can be UE/NCR-MT specific CSI-RS, SRS, etc.

In a further embodiment, the periodic repeater beam configuration is associated to forward slots/symbols configured for Semi-Persistent Scheduling (SPS) in DL or Configured Grant (CG) in UL.

In one embodiment, network node 502 can update the periodic beam configurations in selection of one or more of
TDD pattern is reconfigured;
certain cell common signals/channels are reconfigured; and
certain periodic reference signals are reconfigured.

In step 708, the method includes providing the repeater node 504 with one or more dynamic beam indications.

In one embodiment, the dynamic beam indication is configured based on the real-time UE scheduling of one or more of:
Physical Downlink Shared Channel (PDSCH)/Physical Downlink Control Channel (PDCCH)/Physical Uplink Shared Channel (PUSCH), or Physical Uplink Control Channel (PUCCH); and
Aperiodically activated measurement of reference signals e.g., SSB/CSI-RS/SRS In one embodiment, the dynamic beam indications are conveyed in e.g., DCI etc.

In one embodiment, network node 502 indicates the set of repeater beams-to-use based on the information in the repeater beam arrangement report using one or more of
Repeater beam index/ID;
Repeater beam index/ID+repeater beam type index/ID;
Repeater beam polarization index/ID;
Reference signal in the TCI configuration;
A bitfield, where each bit in the bitfield is associated to a beam according to the repeater beam arrangement report;
A bitfield per beam type, where each bit in the bitfield is associated with a beam of that beam type according to the repeater beam arrangement report; and
Initial proto-beam(s) and/or proto-beam antenna size(s) and/or proto-beam indices.

In one embodiment, the configuration of the beam time-domain state includes one or more of:
a System frame number;
a Sub-frame number;
a Slot number;
a Slot periodicity;
a Duration in number of slots;
a Symbol number;
a Starting Orthogonal Frequency-Division Multiplexing (OFDM) symbol in a slot;
an Ending OFDM symbol in a slot; and
a Duration in number of OFDM symbols in a slot.

It should be noted that the periodic beam configuration may comprise a periodic beam time-domain state and a periodic beam-to-use, whilst the dynamic beam indication may comprise a periodic beam time-domain state and an aperiodic beam-to-use, or an aperiodic beam time-domain state and an aperiodic beam-to-use.

In one embodiment, the beam configuration/indication can be related to other repeater node configurations such as:
Repeater FWD OFF configuration, in which case the repeater access side is not operable and only the repeater Modem module is practically active. In one embodiment, the OFF configuration could be or result from a certain beam index outside the range of actual beam indices.
Repeater INACTIVE or IDLE, in which case the whole repeater becomes inactivated at various levels. This could be, e.g., in a shopping mall outside opening hours.
Beam amplification level, i.e., which amplification should be applied for the beam.
   In one embodiment the beam amplification factor is different depending on the beamwidth of the repeater node's spatial filter. In one example, the larger the beamwidth that is used, the higher the amplification factor is (to compensate for the lower antenna gain when applying spatial filters with larger beamwidths).

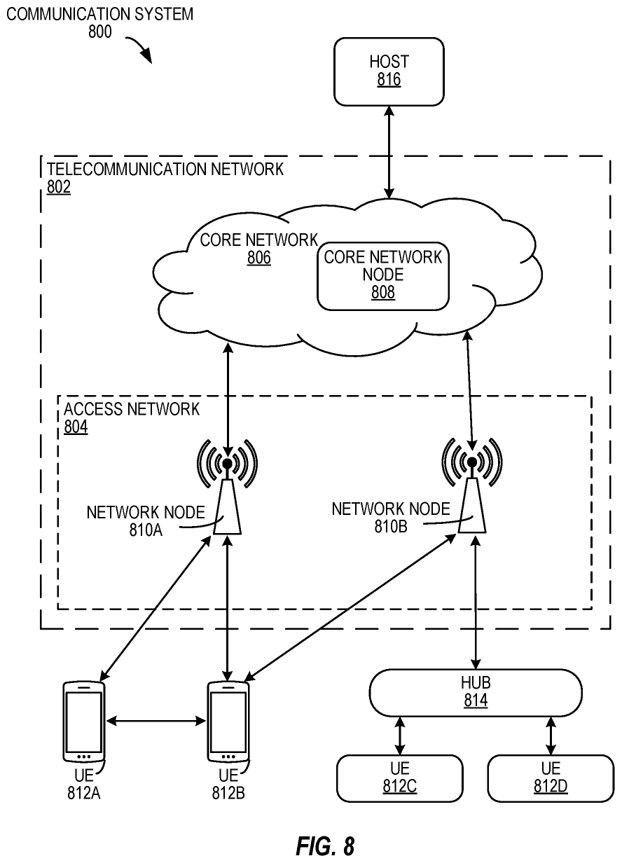

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes (e.g., network node 502), such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of UE, such as by connecting UEs 812A, 812B, 812C, and 812D (one or more of which may be generally referred to as UEs 812) to the core network 806 over one or more wireless connections. In various embodiments as disclosed herein, the network nodes 810 could also configure spatial filters of a repeater forwarding function of repeater nodes (e.g., repeater node 504).

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802 and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or Massive Machine Type Communication (mMTC)/massive Internet of Things (IOT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

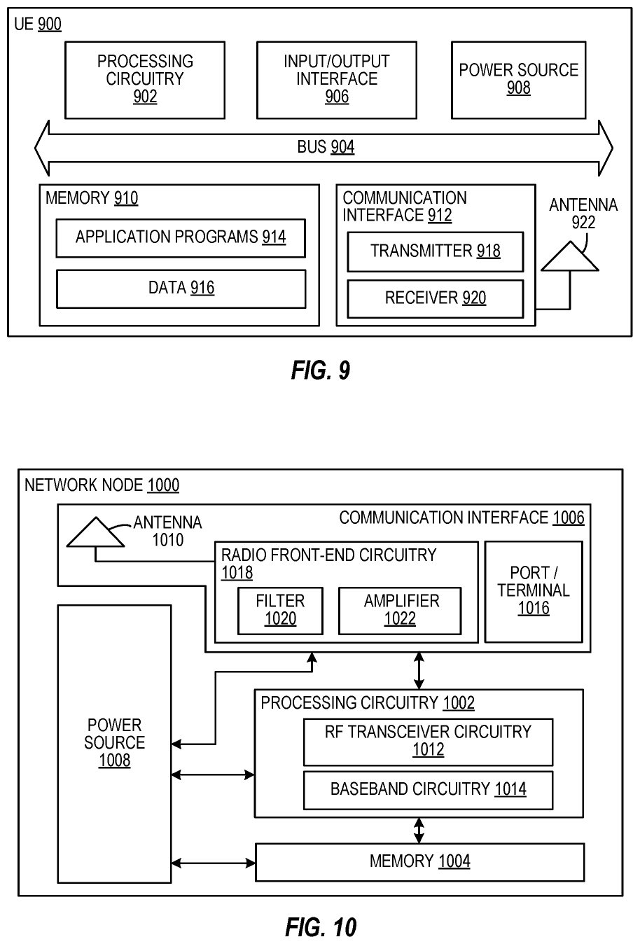

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, a mobile phone, a cell phone, a Voice over Internet Protocol (VOIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, a Laptop Embedded Equipment (LEE), a Laptop Mounted Equipment (LME), a smart device, a wireless Customer Premise Equipment (CPE), a vehicle-mounted or vehicle embedded/integrated wireless device, etc. Other examples include any UE identified by the 3GPP, including a Narrowband Internet of Things (NB-IoT) Ue, a Machine Type Communication (mtc) UE, And/or an Enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), a photovoltaic device, or a power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, a web browser application, a widget, a gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic Random Access Memory (RAM) (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an Embedded UICC (eUICC), Integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M 2M device, which may in a 3GPP context be referred to as an MTC device. As one particular example, the UE may implement the 3GPP NB-IOT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, Evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, a controller, a microcontroller, a CPU, a DSP, an ASIC, a FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

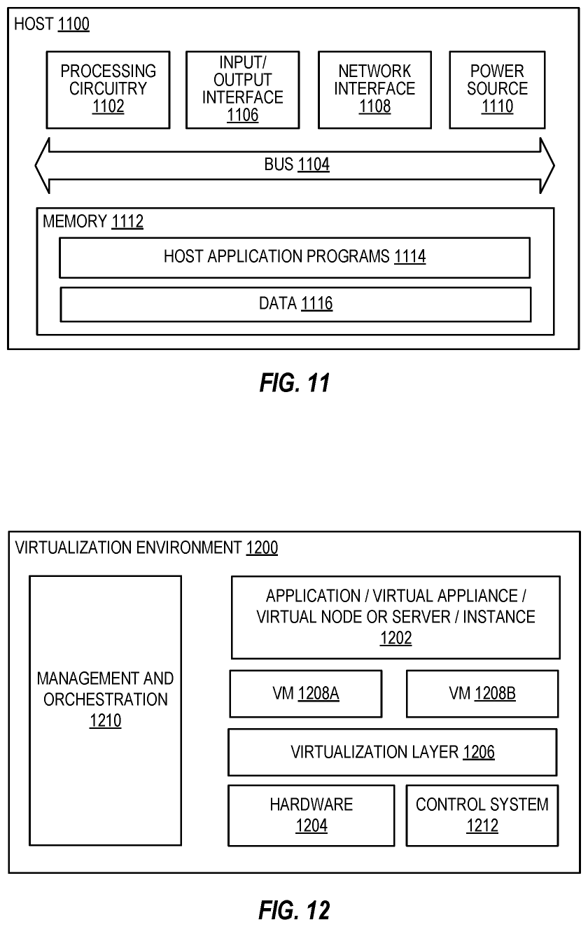

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems).

The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

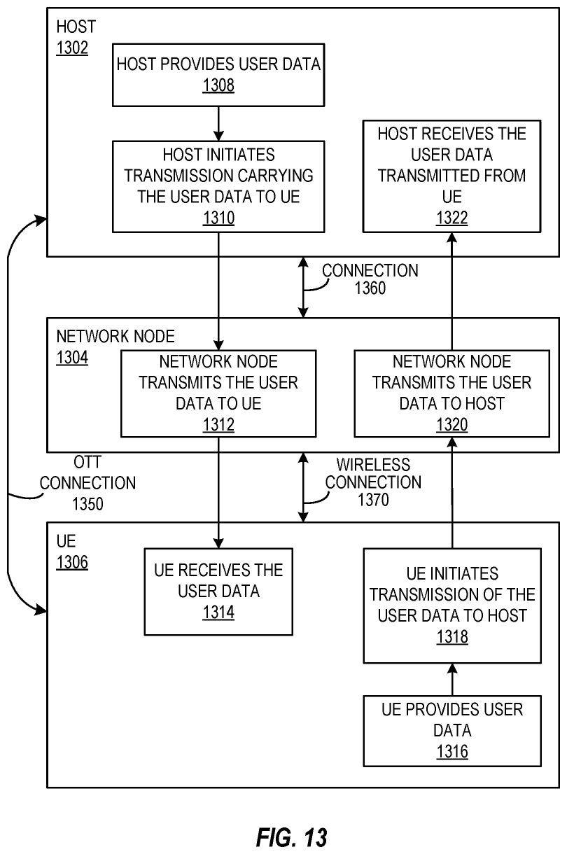

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the ability of network nodes to configure the spatial filters of repeater nodes which enable the repeater node to not be required to have an understanding of the signals/channels, such as PDCCH, PUCCH, PDSCH, PUSCH, SSB, PRACH etc., which can more easily and cheaply enable repeater nodes to be deployed.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc. ; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Embodiment 1: A method performed by a repeater node (504) for configuring a spatial filter of a repeater forwarding function, the method comprising receiving (604), from a network node (502), one or more periodic beam configurations. The method can also include receiving (606), from the network node (502), one or more dynamic beam indications. The method can also include selecting (608) a periodic beam configuration from the one or more periodic beam configurations or a dynamic beam indication from the one or more dynamic beam indications to use for a time interval based on a prioritization order. The method can also include applying (610) the periodic beam configuration or the dynamic beam indication for a beam of a transmission.

Embodiment 2: The method of embodiment 1, the method further includes, prior to receiving the one or more periodic beam configurations, providing (602) to the network node (502) a capability report comprising at least one or more of the following capabilities, function as a repeater, receive dynamic beam indication, beam arrangement report, beam capability report, latency requirements for dynamic indication, and on/off capability.

Embodiment 3: The method of any of the previous embodiments, wherein each of the one or more periodic beam configurations and the one or more dynamic beam indications have a respective priority.

Embodiment 4: The method of embodiment 3, wherein the one or more periodic beam configurations and the dynamic beam indications with a highest priority level is selected.

Embodiment 5: The method of any of the previous embodiments, wherein the one or more periodic beam configurations includes one or more beam configurations for all periodic signals and/or channels to be forwarded.

Embodiment 6: The method of any of the previous embodiments, wherein the one or more periodic beam configurations are semi-static and each periodic beam configuration of the one or more periodic beam configurations are associated with a respective periodicity.

Embodiment 7: The method of any of the previous embodiments, wherein the one or more periodic beam configurations are recurring with periodic signals and/or channels to be forwarded.

Embodiment 8: The method of any of embodiments 1-2, wherein at least one periodic beam configuration of the one or more of periodic beam configuration is associated with a priority flag.

Embodiment 9: The method of embodiment 8, wherein the periodic beam configuration with the priority flag is selected.

Embodiment 10: The method of any of embodiments 1-9, wherein a dynamic beam indication is associated with a reference to an associated periodic beam configuration.

Embodiment 11: The method of embodiment 10, wherein the associated periodic beam configuration is selected.

Embodiment 12: The method of any of embodiments 1-11, wherein a beam to use of a transmission is indicated using information based on a beam arrangement report, includes one or more of beam index/identification, beam index/identification and beam type index/identification, reference signal of a transmission configuration indicator state, polarization index/identification, a bitfield, where each bit in the bitfield is associated with a beam according to the beam arrangement report, a bitfield per beam type, wherein each bit in the bitfield is associated with a beam of that beam type according to the beam arrangement report, a beam expansion factor and a beam index, and an OFF beam for disabled repeater operation.

Embodiment 13: The method of any of embodiments 1-12, wherein the one or more periodic beam configurations and the one or more dynamic beam indications include respective beam time-domain states that include one or more of a system frame number, a sub-frame number, a slot number, a slot periodicity, a duration in number of slots, a starting OFDM symbol in a slot, an ending OFDM symbol in a slot, and a duration in number of OFDM symbols.

Embodiment 14: The method of embodiment 12, wherein the beam to use is associated with a periodic beam configuration that can be updated dynamically.

Embodiment 15: The method of embodiment 14, wherein the beam to use can be updated with Downlink Control Information, DCI, or a Medium Access Control, MAC, Control Element, MAC-CE.

Embodiment 16: The method of any of embodiments 1-15, wherein the one or more periodic beam configurations is received via a Radio Resource Control, RRC, or MAC-CE signaling.

Embodiment 17: The method of any of embodiments 1-16, wherein the one or more dynamic beam indications is received via DCI.

Embodiment 18: The method of any of embodiments 1-17, wherein the repeater node (504) is at least one of a network-controlled repeater device or a Reconfigurable Intelligent Surface, RIS, device.

Embodiment 19: A repeater node (504) for configuring a spatial filter of a repeater forwarding function, the repeater node (504) including processing circuitry configured to perform any of the steps of any of embodiments 1-18, and power supply circuitry configured to supply power to the processing circuitry.

Embodiment 20: A method performed by a network node (502) for configuring a spatial filter of a repeater forwarding function, the method including determining (704) a priority list for a plurality of repeater spatial filters for a repeater node (504), providing (706) the repeater node (504) with one or more periodic beam configurations based on the priority list, and providing (708) the repeater node (504) with one or more dynamic beam indications.

Embodiment 21: The method of embodiment 20, the method further including prior to determining the priority list, receiving (702) from the repeater node (504) a capability report including at least one or more of the following capabilities, function as a repeater, receive dynamic beam indication, beam arrangement report, beam capability report, latency requirements for dynamic indication, on/off capability.

Embodiment 22: The method of any of embodiments 20-21, wherein each of the one or more periodic beam configurations and the one or more dynamic beam indications have a respective priority.

Embodiment 23: The method of any of embodiments 20-21, wherein at least one periodic beam configuration of the one or more periodic beam configurations is associated with a priority flag.

Embodiment 24: The method of embodiment 20, wherein at least one dynamic beam indication of the one or more dynamic beam indications is associated with a reference to a periodic beam configuration.

Embodiment 25: The method of any of embodiments 20-24, wherein the priority list for a plurality of repeater spatial filters is based on an importance of a signal/channel to be forwarded.

Embodiment 26: The method of any of embodiments 20-24, wherein the priority list for a plurality of repeater spatial filters is based on a carrier/serving cell on which a signal/channel to be forwarded is scheduled.

Embodiment 27: The method of any of embodiments 20-26, wherein the one or more periodic beam configurations include one or more beam configurations for all periodic signals/channels to be forwarded.

Embodiment 28: The method of any of embodiments 20-27, wherein at least one periodic beam configuration of the one or more periodic beam configurations are associated with forward slots/symbols configured to cell common signals/channels.

Embodiment 29: The method of any of embodiments 20-28, wherein at least one periodic beam configuration of the one or more periodic beam configurations are associated with forward slot/symbols configured for User Equipment, UE, Network Controlled Repeater Mobile Termination, NCR-MT, or specific periodic reference signals, including at least one of a Channel State Information Reference Signal, CSI-RS, or a Sounding Reference Signal, SRS.

Embodiment 30: The method of any of embodiments 20-28, wherein at least one periodic beam configuration of the one or more periodic beam configurations are associated with forward slot/symbols configured for Semi Persistent Scheduling, SPS, in a downlink channel or a Configured Grant, CG, in an uplink channel.

Embodiment 31: The method of any of embodiments 20-30, wherein the one or more of periodic beam configurations are semi-static, and each periodic beam configuration of the one or more periodic beam configurations is associated with a periodicity.

Embodiment 32: The method of any of embodiments 20-30, wherein the one or more of periodic beam configurations are recurring with periodic signals/channels to be forwarded.

Embodiment 33: The method of any of embodiments 20-32, wherein the one or more dynamic beam indications are associated with forward slots/symbols configured to dynamically scheduled signals/channels.

Embodiment 34: The method of any of embodiments 20-32, wherein the one or more dynamic beam indications are associated with forward slots/symbols configured to aperiodic reference signals.

Embodiment 35: The method of any of embodiments 20-34, wherein a beam to use of a transmission is indicated using information based on a beam arrangement report, including one or more of beam index/identification, beam index/identification and beam type index/ identification, reference signal of a transmission configuration indicator state, polarization index/identification, a bitfield, where each bit in the bitfield is associated with a beam according to the beam arrangement report, a bitfield per beam type, wherein each bit in the bitfield is associated with a beam of that beam type according to the beam arrangement report, a beam expansion factor and a beam index, and an OFF beam for disabled repeater operation.

Embodiment 36: The method of any of embodiments 20-35, wherein the one or more periodic beam configurations and the one or more dynamic beam indications include respective beam time-domain states that include one or more of a system frame number, a sub-frame number, a slot number, a slot periodicity, a duration in number of slots, a starting OFDM symbol in a slot, an ending OFDM symbol in a slot, and a duration in number of OFDM symbols.

Embodiment 37: The method of embodiment 35, wherein the beam to use is associated with a periodic beam configuration that can be updated dynamically.

£ Embodiment 38: The method of embodiment 37, wherein the beam to use can be updated with Downlink Control Information, DCI, or a Medium Access Control, MAC, Control Element, MAC-CE.

Embodiment 39: The method of any of embodiments 20-38, wherein the one or more periodic beam configurations is provided via a Radio Resource Control, RRC, or MAC-CE signaling.

Embodiment 40: The method of any of embodiments 20-39, wherein the one or more dynamic beam indications is provided via DCI.

Embodiment 41: A network node (502) for configuring a spatial filter of a repeater forwarding function, the network node (502) including processing circuitry configured to perform any of the steps of any of embodiments 20-38, and power supply circuitry configured to supply power to the processing circuitry.

Those skilled in the art will recognize improvements and modifications to the embodiments of the present disclosure. All such improvements and modifications are considered within the scope of the concepts disclosed herein.

1. A method performed by a repeater node for configuring a spatial filter of a repeater forwarding function, the method comprising:
receiving, from a network node, one or more periodic beam configurations;
receiving, from the network node, one or more dynamic beam indications;
selecting a periodic beam configuration from the one or more periodic beam configurations or a dynamic beam indication from the one or more dynamic beam indications to use for a time interval based on a prioritization order; and
applying the periodic beam configuration or the dynamic beam indication for a beam of a transmission.

2. The method of claim 1, the method further comprising:
prior to receiving the one or more periodic beam configurations, providing to the network node a capability report comprising at least one or more of the following capabilities:
function as a repeater;
receive dynamic beam indication;
beam arrangement report;
beam capability report;
latency requirements for dynamic indication; and
on/off capability.

3-7. (canceled)

8. The method of claim 1, wherein at least one periodic beam configuration of the one or more of periodic beam configuration is associated with a priority flag.

9. The method of claim 8, wherein the periodic beam configuration with the priority flag is selected.

10-15. (canceled)

16. The method of claim 1, wherein the repeater node is at least one of a network-controlled repeater device or a Reconfigurable Intelligent Surface (RIS) device.

17. A repeater node for configuring a spatial filter of a repeater forwarding function, the repeater node comprising processing circuitry configured to:
receive from a network node, one or more periodic beam configurations;
receive from the network node, one or more dynamic beam indications;
select a periodic beam configuration from the one or more periodic beam configurations or a dynamic beam indication from the one or more dynamic beam indications to use for a time interval based on a prioritization order; and
apply the periodic beam configuration or the dynamic beam indication for a beam of a transmission.

18. (canceled)

19. A method performed by a network node for configuring a spatial filter of a repeater forwarding function, the method comprising:
determining a priority list for a plurality of repeater spatial filters for a repeater node
providing the repeater node with one or more periodic beam configurations based on the priority list; and
providing the repeater node with one or more dynamic beam indications.

20. (canceled)

21. The method of claim 19, wherein each of the one or more periodic beam configurations and the one or more dynamic beam indications have a respective priority.

22. (canceled)

23. The method of claim 19, wherein at least one dynamic beam indication of the one or more dynamic beam indications is associated with a reference to a periodic beam configuration.

24. The method of claim 19, wherein the priority list for a plurality of repeater spatial filters is based:
on an importance of a signal/channel to be forwarded, or
on a carrier/serving cell on which a signal/channel to be forwarded is scheduled.

25. (canceled)

26. The method of claim 19, wherein the one or more periodic beam configurations comprise one or more beam configurations for all periodic signals/channels to be forwarded.

27. (canceled)

28. The method of claim 19, wherein at least one periodic beam configuration of the one or more periodic beam configurations are associated with forward slot/symbols configured for User Equipment (UE) Network Controlled Repeater Mobile Termination (NCR-MT) or specific periodic reference signals, including at least one of a Channel State Information Reference Signal (CSI-RS) or a Sounding Reference Signal (SRS).

29. The method of claim 19, wherein at least one periodic beam configuration of the one or more periodic beam configurations are associated with forward slot/symbols configured for Semi Persistent Scheduling (SPS) in a downlink channel or a Configured Grant (CG) in an uplink channel.

30. The method of claim 19, wherein the one or more of periodic beam configurations are semi-static, and each periodic beam configuration of the one or more periodic beam configurations is associated with a periodicity.

31. The method of claim 19, wherein the one or more of periodic beam configurations are recurring with periodic signals/channels to be forwarded.

32. The method of claim 19, wherein the one or more dynamic beam indications are associated with forward slots/symbols configured to dynamically scheduled signals/channels.

33. The method of claim 19, wherein the one or more dynamic beam indications are associated with forward slots/symbols configured to aperiodic reference signals.

34. The method of claim 19, wherein a beam to use of a transmission is indicated using information based on a beam arrangement report, comprising one or more of:
beam index/identification;
beam index/identification and beam type index/identification;
reference signal of a transmission configuration indicator state;
polarization index/identification;
a bitfield, where each bit in the bitfield is associated with a beam according to the beam arrangement report;
a bitfield per beam type, wherein each bit in the bitfield is associated with a beam of that beam type according to the beam arrangement report;
a beam expansion factor and a beam index; and
an OFF beam for disabled repeater operation.

35. The method of claim 19, wherein the one or more periodic beam configurations and the one or more dynamic beam indications comprise respective beam time-domain states that comprise one or more of:
a system frame number;
a sub-frame number;
a slot number;
a slot periodicity;
a duration in number of slots;
a starting Orthogonal Frequency-Division Multiplexing (OFDM) symbol in a slot;
an ending OFDM symbol in a slot; and
a duration in number of OFDM symbols.

36. The method of claim 34, wherein the beam to use is associated with a periodic beam configuration that can dynamically updatable.

37. (canceled)

38. The method of claim 19, wherein the one or more periodic beam configurations is provided via a Radio Resource Control (RRC) or MAC-CE signaling.

39. The method of claim 19, wherein the one or more dynamic beam indications is provided via DCI.

40. A network node for configuring a spatial filter of a repeater forwarding function, the network node comprising processing circuitry configured to:
determine a priority list for a plurality of repeater spatial filters for a repeater node
provide the repeater node with one or more periodic beam configurations based on the priority list; and
provide the repeater node with one or more dynamic beam indications.

41. (canceled)
